(19) United States
(12) Patent Application Publication
(10) Pub. No.: US 2023/0410238 A1
(43) Pub. Date: Dec. 21, 2023

(54) Assisting at Risk Individuals

(71) Applicant: Bank of America Corporation, Charlotte, NC (US)

(72) Inventor: Stacy Bennett, Fort Mill, SC (US)

(21) Appl. No.: 17/837,921

(22) Filed: Jun. 10, 2022

(51) Int. Cl. G06Q 50/26; G06Q 30/00; G06Q 40/00

(52) U.S. Cl. CPC G06Q 50/265; G06N 20/00; G06Q 40/12; G06Q 30/0185

(57) ABSTRACT

Computer-implemented human trafficking detection utilizing artificial intelligence and/or machine learning—is disclosed to detect illicit businesses through sex-buyer behavior and the merchants they frequent. Customers exhibiting sex buyer patterns of behavior are identified and scored based on multiple factors. Merchants paid by these flagged customers are scored based on the behavior of all their customers (not only their sex buyer flagged customers) to measure the extent of illicit and legitimate services provided, and identify those likely involved in human trafficking. Similarity function(s) match likely illicit merchants to customers' business accounts. Matching business accounts can be measured for any additional red flags. Once business accounts for IMBs are detected, entire criminal networks can be identified based on shared social data (addresses, phone numbers, TINs) of the IMB customer profile as well as identifying any counterparties doing business with the IMB accounts.

### TECHNICAL FIELD OF DISCLOSURE

The present disclosure relates to processes and machines for data processing utilizing artificial intelligence and to a knowledge processing system and methodology that comprises specific domain data that is integrated as a collection of facts and relationships (i.e., knowledge representation) and that applies various reasoning techniques to detect human trafficking.

### BACKGROUND

Financial institutions are required by the United States government to detect and prevent money laundering. FinCEN, the Financial Crimes Enforcement Network regulatory bureau, recently included human-trafficking detection as a priority for financial institutions.

The NGO Polaris analyzed more than 32,000 cases of human trafficking documented between December 2007 and December 2016 for their report published March 2017. Polaris identified 25 industries that are associated with human trafficking (including sex and labor trafficking). The top two industries identified in this report (based on the number of cases) were: escort services and illicit massage businesses (IMBs). Polaris currently assesses that there are at least 9,000 illicit massage businesses located in the United States

Peer-to-peer review sites for IMBs for customers seeking more than a massage exist. Sex buyers leave reviews and ratings for the IMBs, including sex services offered, pricing, payment options, physical attributes of the provider, etc. Subscriptions are usually required to gain access to IMB reviews.

Human-trafficking detection is challenging because human-trafficking businesses typically appear legitimate and often provide legitimate services (such as massage parlors) in addition to illicit services. These businesses have typical business expenses, pay taxes, have proper certifications and permits, etc. Consequently, they are difficult to detect using only bank transaction data. Attempting to detect these businesses directly results in too many false positives, wasted effort, and little impact to human trafficking. Victims are difficult to detect using bank data since these victims do not typically have control over or access to finances.

Unfortunately, very few proactive, automated, human-trafficking detection methods exist. Those which do attempt to detect the financial or other accounts of human-trafficking businesses or victims directly, which results in inaccurate and low-quality output with poor results.

These problems underscore the need to improve human-trafficking detection systems and methods.

### SUMMARY

In accordance with one or more arrangements of the disclosures contained herein, solution(s) are provided to address one or more of the shortcomings in industries, institutions, and systems for detecting human trafficking by, for example, (a) leveraging customer transactions to detect and score sex buyers, which then lead to identification of the illicit businesses via merchant payments, which lead to identification of larger criminal networks; (b) using sex buyers, instead of business or victim accounts, as an entry point; and (c) utilizing scoring methods to measure both buyers and buyer merchants.

Instead of attempting to detect human trafficking businesses or victims directly, various aspects of this disclosure detect illicit businesses through the behavior of the sex buyers and the merchants those buyers' frequent. This is very beneficial because buyers, as opposed to illicit businesses, are the least educated in detection capabilities and have the least amount of risk associated with this illegal activity so buyer transactions are more directly indicative of their role in human trafficking.

Customers exhibiting sex buyer patterns of behavior can be identified and scored based on multiple factors. Merchants paid by flagged customers can be scored based on the behavior of all their customers (not only their sex buyer flagged customers) to measure the extent of illicit and legitimate services provided. Based on the scoring of these merchants and the merchants' customers' behaviors, merchants likely involved in human trafficking can be identified.

Similarity functions and comparisons can be applied to match likely illicit merchants to business accounts. The matching business accounts can be measured for any additional red flags such as ratio of cash deposits to total incoming, wire transfers, crypto, and person to person transfers.

Once business accounts for IMBs are detected, entire criminal networks can be identified based on shared social data (addresses, phone numbers, TINs) of IMB customer profile(s) and any counterparties doing business with the IMB accounts can also be identified. The output can be used to refer human-trafficking cases to the appropriate authorities and to submit suspicious activity reports (SARs).

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a computer-implemented human-trafficking detection process can comprise the steps of: identifying, by a human-trafficking detection server from a subscriber datastore, a list of one or more subscribers to analyze based on detection criteria; retrieving, by the human-trafficking detection server from the subscriber datastore into a first sector of server memory, one or more subscribers to analyze; retrieval, by the human-trafficking detection server from a financial transaction datastore into a second sector of the server memory, a plurality of subscriber financial transactions that were executed by said one or more subscribers, said plurality of subscriber transactions having transaction amounts; storing, by the human-trafficking detection server in a third sector of server memory, the transaction amounts by transaction date; filtering, by the human-trafficking detection server based on business type, the plurality of subscriber financial transactions to identify suspect businesses potentially providing sex-buyer services; storing, by the human-trafficking detection server in a fourth sector of server memory, the plurality of subscriber financial transactions; retrieving, by the human-trafficking detection server from an ATM datastore, cash withdrawals and cash advances by the subscriber; storing, by the human-trafficking detection server in a fifth sector of server memory, the cash withdrawals and the cash advances by ATM date; calculating, by the human-trafficking detection server, summations of the cash withdrawals, the cash advances, and the transaction amounts based on the transaction date and the ATM date; storing, by the human-trafficking detection server into a sixth sector of the server memory, the summations based on the transaction date and the ATM date; identifying, by the human-trafficking detection server, potential sex businesses from the suspect businesses based on a correlation of the summations of the cash withdrawals and the cash advances to the transaction amounts by said transaction date and said ATM date, wherein said suspect businesses are more likely to be said potential sex businesses based on a concentration of a quantity of subscribers having higher average summations; and storing, by the human-trafficking detection server into a seventh sector of server memory, the potential sex businesses.

In some arrangements, the identification of said potential sex businesses is determined utilizing artificial intelligence and/or machine learning. Such artificial intelligence may include Naive Bayes, Decision Tree, Random Forest, Support Vector Machines, K Nearest Neighbors, Linear Regression, Lasso Regression, Logistic Regression, Multivariate Regression, Multiple Regression, K-Means Clustering, Fuzzy C-mean, Expectation-Maximisation, and Hierarchical Clustering. Machine learning may be supervised machine learning, semi-supervised machine learning, unsupervised machine learning, and/or utilize natural language processing.

In some arrangements, the identification of said potential sex businesses may alternatively and/or additionally be determined by executing one or more IMB detection steps such as, for example, calculating, by the human-trafficking detection server, an IMB subscriber review total; calculating, by the human-trafficking detection server, a spa/salon merchant total; calculating, by the human-trafficking detection server, an IMB detection total; calculating, by the human-trafficking detection server, an initial party ID match total; calculating, by the human-trafficking detection server, a high confidence party ID match total; calculating, by the human-trafficking detection server, an identification of open accounts; and calculating, by the human-trafficking detection server, an identification of said open accounts that have made one or more commercial sex advertisement payments, wherein a likelihood of whether the potential sex business is an IMB is directly proportional to a cumulation of said one or more IMB detection steps.

In some arrangements, the identification of potential sex businesses may alternatively and/or additionally be determined by executing one or more IMB scoring metric steps such as, for example, determining, by the human-trafficking detection server, a sex buyer site subscriber percent; calculating, by the human-trafficking detection server, an average spa/salon payment transaction amount; identifying, by the human-trafficking detection server, a same day withdrawal percentage; calculating, by the human-trafficking detection server, an average same day withdrawal amount; determining, by the human-trafficking detection server, a network party count; determining, by the human-trafficking detection server, a network spa count; calculating, by the human-trafficking detection server, a cash deposit incoming transaction percentage; calculating, by the human-trafficking detection server, a cash withdrawal outgoing transaction percentage; identifying, by the human-trafficking detection server, a commercial sex advertisement transaction count; determining, by the human-trafficking detection server, whether one or more said potential sex businesses has a suspicious activity report indicator; determining, by the human-trafficking detection server, whether one or more said potential sex businesses has a NAICS code or business description related to logistics, freight, or transport; calculating, by the human-trafficking detection server, a cryptocurrency transaction account; and calculating, by the human-trafficking detection server, a burner phone transaction count, wherein a likelihood of whether the potential sex business is an IMB is directly proportional to a cumulation of said one or more IMB scoring metrics.

In some arrangements, one or more various steps, processes, and/or functions can be implemented, in whole or in part, in conjunction with machine(s) having computer-executable instructions stored on one or more local or distributed computer-readable media potentially along with various data that are executed by one or more application integrated circuits (ASICs), processors, or the like that are communicatively coupled with various machine(s) and device(s) by any type of suitable wired and/or wireless protocol(s), network(s) (e.g., local, wide area, ultrawideb and, etc.), communication busses, etc. such as generally depicted, as merely one example, in FIG. 1. A skilled artisan will readily appreciate that this disclosure is extremely broad in this regard and is not in any way limited to the example of FIG. 1.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 depicts exemplary operating environment(s) and functionality to implement one or more aspects of this disclosure to provide improvements in a knowledge processing system and methodology that comprises specific business and subscriber domain data that is integrated as a collection of facts and relationships (i.e., knowledge representation) and that applies various reasoning techniques, artificial intelligence, machine learning, and/or other processing to detect human trafficking.

FIG. 2 is a sample high-level overview and flow diagram in which various aspects of this disclosure can be implemented.

FIG. 3 is a sample high-level overview and flow diagram in which various aspects of this disclosure pertaining to IMB detection code can be implemented.

FIG. 4 is a sample high-level overview and flow diagram in which various aspects of this disclosure pertaining to IMB scoring metrics can be implemented.

FIG. 5 is a sample high-level graphical analysis correlating subscriber counts to average spa payments+same day cash withdrawal amounts to identify payments to IMB review sites in which businesses with a higher concentration of subscriber customers, higher payment averages, and same day cash withdrawal frequencies can be identified as potential IMBs.

FIG. 6 depicts sample IMB customer metrics that can be utilized to implement one or more aspects of this disclosure.

FIG. 7 depicts sample IMB payments and cash withdrawals by date as well as just for pleasure purchases that can be utilized to implement one or more aspects of this disclosure.

FIG. 8 is a sample high-level overview in which various aspects of this disclosure pertaining to refactored and enhanced IMB detection code can be utilized to implement one or more aspects of this disclosure.

### DETAILED DESCRIPTION OF THE DISCLOSURE

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, (including ATMs, POS, self-service teller, public terminals, etc.) or the like (e.g., 100, 102, 112, 114, 180 . . . 180N, 190 . . . 190N etc.) can include one or more general-purpose, customized, configured, special-purpose, virtual, physical, and/or network-accessible devices such as: administrative computers, artificial intelligence systems, clients, clusters, compliance watchers, computing devices, computing platforms, controlled computers, controlled computers, controlling computers, desktop computers, distributed systems, enterprise computers, instances, laptop devices, machine learning systems, monitors or monitoring systems, nodes, notebook computers, personal computers, portable electronic devices, servers, smart devices, streaming servers, tablets, and/or workstations, which may have one or more ASICs, microprocessors, cores, executors etc. for executing, accessing, controlling, implementing etc. various software, computer-executable instructions, data, modules, processes, routines, or the like as discussed below.

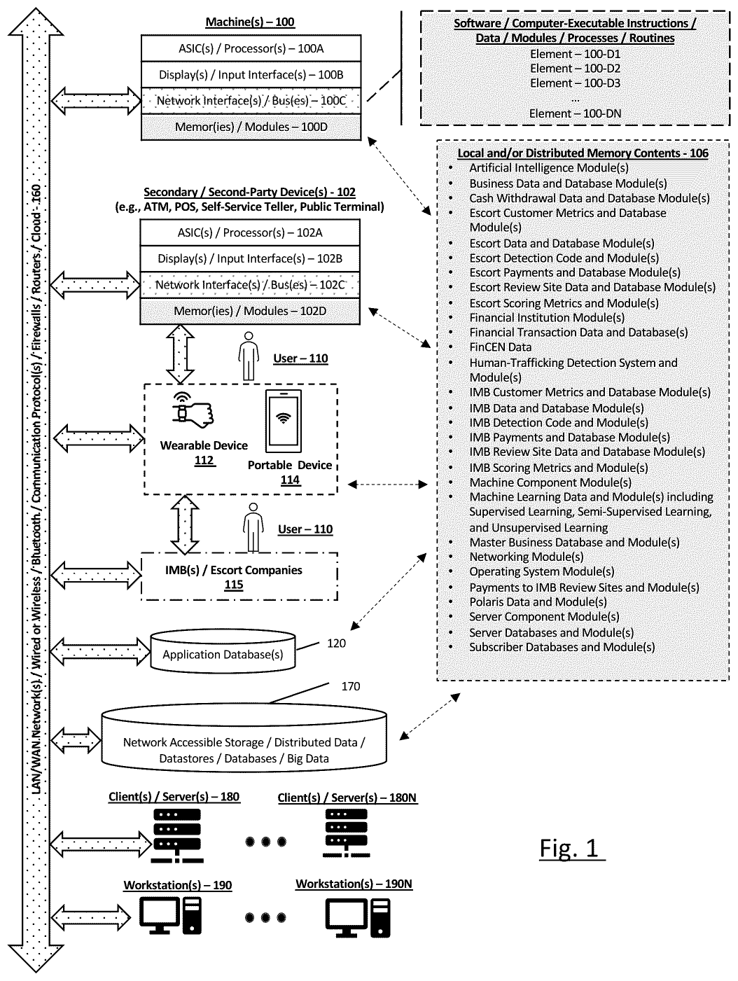

References to computers, machines, or the like as in the examples above are used interchangeably in this specification and are not considered limiting or exclusive to any particular type(s) of electrical device(s), or component(s), or the like. Instead, references in this disclosure to computers, machines, or the like are to be interpreted broadly as understood by skilled artisans. Further, as used in this specification, computers, machines, or the like also include all hardware and components typically contained therein such as, for example, ASICs, processors, executors, cores, etc. (e.g., 100A, 102A, etc.), display(s) and/or input interfaces/devices (e.g., 100B, 102B, etc.), network interfaces, communication buses, or the like (e.g., 100C, 102C, etc.), and memories or the like (e.g., 100D, 102D, etc.), which can include various sectors, locations, structures, or other electrical elements or components (for brevity these are not separately shown for a user's 110 wearable device 112 or portable device 114). Other specific or general components, machines, or the like are not depicted in the interest of brevity and would be understood readily by a person of skill in the art. One or more sample(s) of the foregoing, some of which are expressly depicted, can be seen in FIG. 1 along with their associated components, subcomponents, related elements, sub-elements, etc.

As used throughout this disclosure, software, computer-executable instructions, data, modules, processes, routines, or the like can include one or more: active-learning, algorithms, alerts, applications, application program interfaces (APIs), artificial intelligence, attachments, big data, cryptography, cryptographic hashes, daemons, databases, datasets, drivers, data structures, emails, encryptions, file systems or distributed file systems, firmware, governance rules, graphical user interfaces, hashes, images, instructions, machine learning (including supervised learning, semi-supervised learning, reinforcement learning, unsupervised learning, and/or natural language processing), middleware, modules, objects, operating systems, platforms, processes, protocols, programs, routines, scripts, tools, utilities, etc.

In the context of this disclosure, artificial intelligence deals with imparting the decisive ability and thinking ability to the human-trafficking detection system and components thereof. It is a blend of computer science, data analytics, and computer-implemented mathematics, and can include classification algorithms (e.g., Naive Bayes, Decision Tree, Random Forest, Support Vector Machines, K Nearest Neighbors, etc.), regression algorithms (e.g., Linear Regression, Lasso Regression, Logistic Regression, Multivariate Regression, Multiple Regression, etc.), clustering algorithms (e.g., K-Means Clustering, Fuzzy C-mean, Expectation-Maximisation, Hierarchical Clustering, etc.), etc. Machine learning in the context of this disclosure is closely related and may be considered in some instances to overlap with artificial intelligence wholly or partially. In the context of this disclosure, machine learning can be supervised, semi-supervised, reinforcement, and/or unsupervised learning. Sample algorithms can include bidirectional LSTM, Logistic Regression, XG Boost, Random Forest, etc. Natural language processing may also be utilized if desired.

The foregoing software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Examples can be seen in FIG. 1 as memor(ies)/module(s) 100D, 102D along with samples of the foregoing generically represented, in one instance for illustrative purposes, as any number of components, modules or the like such as element—100-D1, element—100-D2, element—100-D3, . . . element—100-DN in one or more sectors, locations, components, etc. Some or all the foregoing may additionally and/or alternatively be stored similarly and/or in a distributed manner in application database(s) 120 and/or network accessible storage/distributed data/datastores/databases/big data etc. 170.

Sample local and/or distributed memory (or the like) contents in accordance with the foregoing may include, as shown in sample structure 106, software, computer-executable instructions, data, modules, process, routines or the like, such as: Artificial Intelligence Module(s), Business Data and Database Module(s), Cash Withdrawal Data and Database Module(s), Escort Customer Metrics and Database Module(s), Escort Data and Database Module(s), Escort Detection Code and Module(s), Escort Payments and Database Module(s), Escort Review Site Data and Database Module(s), Escort Scoring Metrics and Module(s), Financial Institution Module(s), Financial Transaction Data and Database(s), FinCEN Data, Human-Trafficking Detection System and Module(s), IMB Customer Metrics and Database Module(s), IMB Data and Database Module(s), IMB Detection Code and Module(s), IMB Payments and Database Module(s), IMB Review Site Data and Database Module(s), IMB Scoring Metrics and Module(s), Machine Component Module(s), Machine Learning Data and Module(s) (including Supervised Learning, Semi-Supervised Learning, Reinforcement Learning, Unsupervised Learning and/or Natural Language Processing), Primary/Controlling Business Database, Networking Module(s), Operating System Module(s), Payments to IMB Review Sites and Module(s), Polaris Data and Module(s), Server Component Module(s), Server Databases and Module(s), Subscriber Databases and Module(s), and other related components, executables, data, modules, etc.

The foregoing software, computer-executable instructions, data, modules, processes, routines, or the like, when executed—individually and/or collectively across—one or more various computers, machines, or the like (or any components therein) may cause ASICs, processor(s), core(s), executor(s), etc. to perform one or more artificial intelligence, machine learning and/or other above-referenced functions relevant to human-trafficking detection and/or may store or otherwise maintain information that may be used in one or more aspects of this disclosure.

As used throughout this disclosure, computer “networks,” topologies, or the like (e.g., 160, etc.) can include one or more local area networks (LANs), wide area networks (WANs), the Internet, clouds, wired networks, wireless networks, digital subscriber line (DSL) networks, frame relay networks, asynchronous transfer mode networks, virtual private networks (VPN), Bluetooth, ultrawideband (UWB), various protocol(s), or any direct or indirect combinations of the same. Networks also include associated equipment and components such as access points, adapters, buses, Bluetooth adapters, ethernet adaptors (physical and wireless), firewalls, hubs, modems, routers, and/or switches UWB adapters, located inside the network, on its periphery, and/or elsewhere, and software, computer-executable instructions, data, modules, processes, routines, or the like executing on the foregoing. Network(s) may utilize any transport that supports HTTP or any other type of suitable communication, transmission, and/or other packet-based or other suitable protocol. One or more sample(s) of the foregoing, some of which are expressly depicted, can be seen in FIG. 1 along with their associated components, subcomponents, related elements, sub-elements, etc.

A user 110 wearing a smart watch 112 or having some other portable smart electronic

device 114, or utilizing a traditional ATM card or credit card can approach a secondary device 102 (e.g., ATM, etc.) and electronically communicate with it either wirelessly such as with a watch, wirelessly enabled credit or debit card, and/or physically such as by physical insertion of an ATM card or credit card into the ATM in order to obtain the relevant same-day cash withdrawals and/or cash advances. Withdrawals and advances may also be grouped together if in close date proximity to one another.

The same user 110 can utilize any of the same devices or cash in conjunction with purchases and/or unlawful IIVIB-related payments (e.g., “tips” to service providers) to IMB(s), escort companies, or the like 115.

Accordingly, and as described briefly above, a skilled artisan will understand that FIG. 1 depicts exemplary operating environment(s) and functionality to implement one or more aspects of this disclosure to provide improvements in a knowledge processing system and methodology that comprises specific business and subscriber domain data that is integrated as a collection of facts and relationships (i.e., knowledge representation) and that applies various reasoning techniques, artificial intelligence, machine learning, and/or other processing to detect human trafficking.

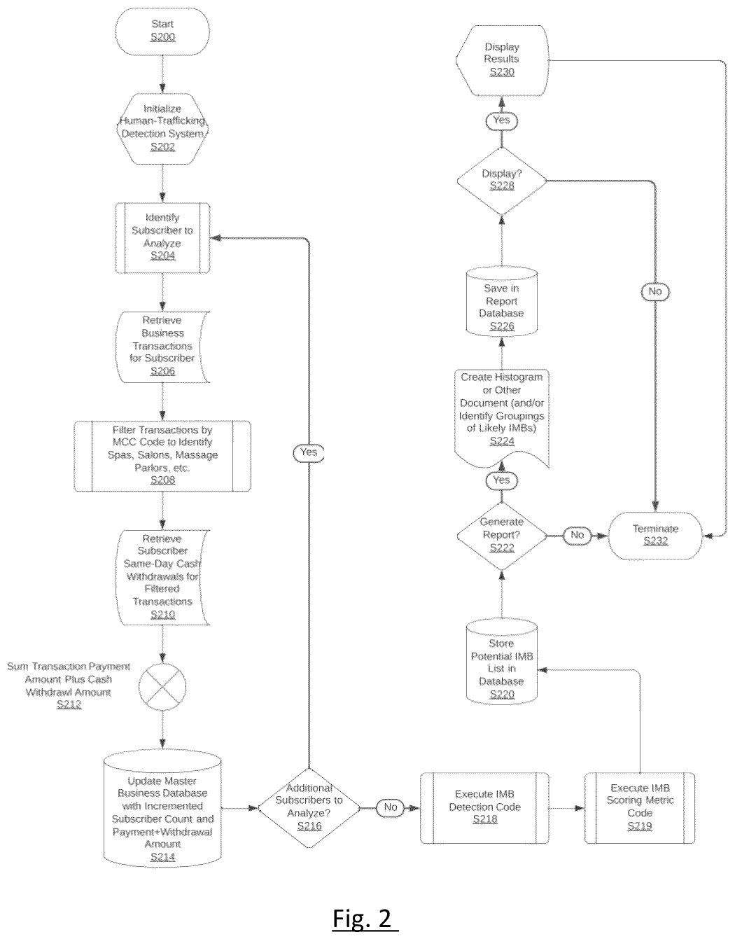

By way of non-limited reference and explanation, a generic, sample, high-level implementation of an artificial intelligence, machine-learning, and/or the like flow diagram is depicted in FIG. 2 to show how to implement one or more aspects of this disclosure. After triggered execution of a process S200, a human-trafficking detection system can be initialized to analyze or extract buyer or subscriber information by artificial intelligence, machine learning, and/or sequential analysis to identify IMB(s) or the like, and then be used via the same or similar functionality to further identify networks of criminal activities including, but not limited to, human trafficking.

An initial subscriber (e.g., financial institution customer who may be a potential sex buyer) can be identified for analysis S204 via the methodology referenced above. Relevant business transactions for the subscriber can be retrieved S206 from appropriate databases or mined from big data, datastores, distributed data, network accessible storage, or the like 170, and/or generated or mined by artificial intelligence, machine learning, and/or other algorithms on data contained therein and/or distributed.

The business or financial transactions can be filtered S208 by merchant category codes (MCCs), which are four-digit numbers that describe a merchant's primary business activities and are used by financial institutions and credit card issuers to identify the type of business in which a merchant is engaged. This can be used to identify potentially relevant business types such as spas, salons, massage parlors, escort companies, etc. This can be accomplished strictly by code matching or more targeted through the use of artificial intelligence, machine learning, and/or other intelligent techniques.

Subscriber same-day cash withdrawals or same-day credit-card cash advances can be retrieved S210 from appropriate databases or mined from big data, datastores, distributed data, network accessible storage, or the like 170, that correspond to the transactions identified in S208. Alternatively, withdrawals and/or advances from dates in close proximity to one another may be considered too.

The business transaction amount(s) plus the same-day cash withdrawals and/or same-day credit-card cash advances can be identified based on the foregoing and summed in S212 in order to identify daily total(s) or totals across a range of dates in close proximity. A primary or controlling business database or other store can be updated with incremented subscriber count(s) and the daily and/or close-proximity range total(s) for future analysis and processing in S214.

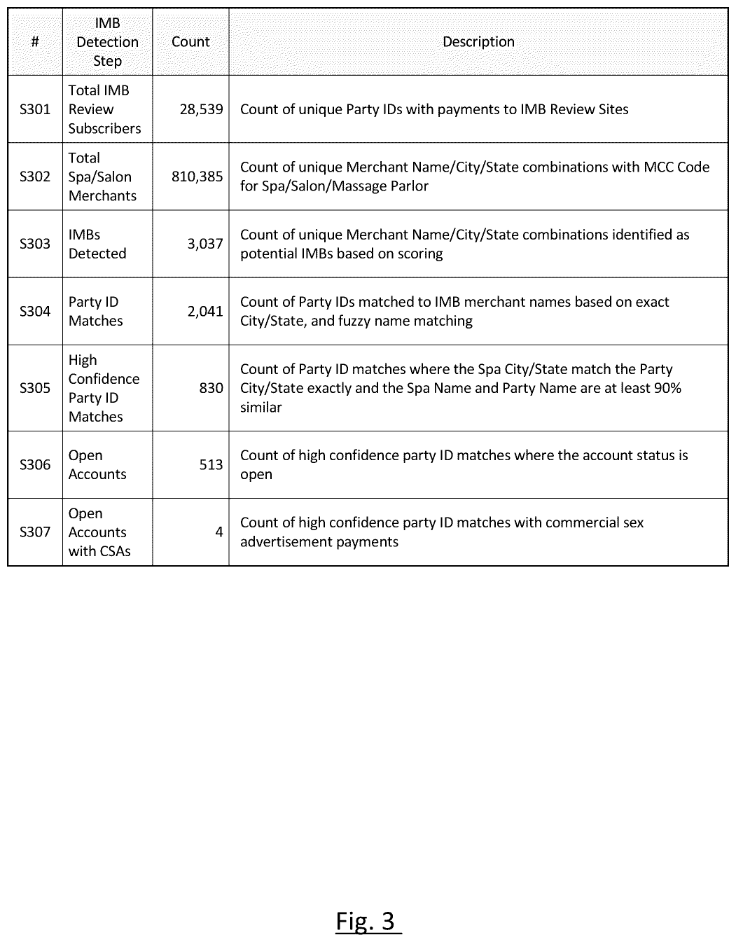

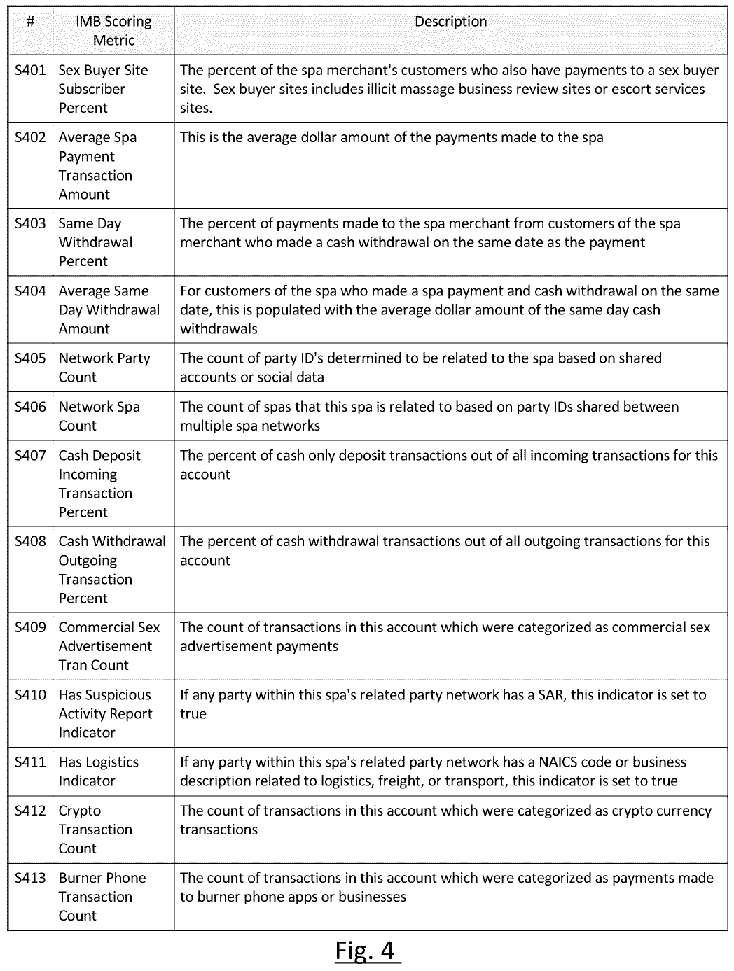

If there are additional subscribers to analyze or if the process is to be repeated on a new date S216, the process may repeat starting at S204. Otherwise, IMB detection code can be executed in S218 (such as in FIG. 3) and IMB scoring metrics (such as in FIG. 4) can be utilized in S219. The resulting potential IMB list may be stored in database(s) or the like in S220. A resulting report can be generated if desired in S222 by creating a histogram or other document to graph and/or correlate relevant data for analysis purposes and/or to identify groupings of likely or potential IMBs in S224 via artificial intelligence, machine learning, or other techniques; otherwise, the processes can conclude S232. Alternatively, the report and/or resulting data can be stored in a database for future reference or analysis in S226. If a display or print is desired in S228, the results may be displayed or printed in S230, after which the processes can terminate in S232.

FIG. 3 is a sample high-level overview and flow diagram in which various aspects of this disclosure pertaining to IMB detection code can be implemented.

In IMB detection step S301, total IMB review subscribers can be identified using artificial intelligence, machine learning, and/or other techniques. The results can then be used to generate a count of the unique Party IDs with payments to IMB review sites. In detection step S302, a total of the spa, salon, massage parlor, or other relevant companies identified by MCC code or other techniques can be calculated. This can be a count of unique merchant name, city, and state combinations with MCC codes for the business type or category that is being flagged. Artificial intelligence, machine learning, or other techniques may be used to identify other MCC codes for future analysis or processing.

In detection step S303, the detected IMBs or the like can be tabulated. This can be the count of unique merchant name, city, and state combinations identified as potential IMBs based on scoring based on artificial intelligence, machine learning, or other processing.

In IMB detection step S304, Party ID matches can be calculated. This can be a count of Party IDs matched to IMB merchant names based on exact cities and states. Fuzzy name matching or other artificial intelligence or machine learning can be utilized.

High confidence Party ID matches can be identified in detection step S305 based on a count of Party ID matches where the spa city/state match the party city/state exactly and/or the spa name and party name are at least 90% similar or satisfy another percentage threshold. Again, artificial intelligence, machine learning, or the like may be helpful in identifying matches and/or setting an optimum threshold.

In IMB detection step S306, open accounts can be identified. This can be a county of high confidence Party ID matches where the account status is open.

In IMB detection step S307, the list can be further narrowed based on open accounts with customer sex advertising (CSA) payments to third-party providers. In particular, this can be a count of high confidence party ID matches with CSA payments. This can yield a list of most likely IMB or the like companies. Again, artificial intelligence, machine learning, or the like may be used to accomplish this list narrowing.

FIG. 4 is a sample high-level overview and flow diagram in which various aspects of this disclosure pertaining to IMB scoring metrics can be implemented. Various IMB scoring metrics can be determined by use of artificial intelligence, machine learning, and/or other intelligent techniques if desired.

In IMB scoring metric step S401, a Sex Buyer Site Subscriber Percent can be calculated. This can be the percent of the spa merchant's customers who also have payments to a sex buyer site. Sex buyer sites includes illicit massage business review sites or escort services sites.

In scoring step S402, an Average Spa Payment Transaction Amount can be calculated. This can be the average dollar amount of the payments made to the spa.

In step S403, a Same Day Withdrawal Percent can be determined. This can be the percent of payments made to the spa merchant from customers of the spa merchant who made a cash withdrawal on the same date as the payment.

In IMB scoring metric step S404, an Average Same Day Withdrawal Amount and/or Credit Card Cash Advance can be calculated. For customers of the spa who made a spa payment and cash withdrawal (or credit card advance) on the same date, this can be populated with the average dollar amount of the same day cash withdrawals.

In S405, a Network Party Count can be determined. This can be the count of party ID's determined to be related to the spa based on shared accounts or social data.

In scoring step S406, a Network Spa Count can be determined. This can be a count of spas that this spa is related to based on party IDs shared between multiple spa networks or based on other criteria. Again, artificial intelligence, machine learning, and/or the like may be useful in these determinations.

In S407, a Cash Deposit Incoming Transaction Percent can be calculated. This can be the percent of cash only deposit transactions out of all incoming transactions for this account.

In IMB scoring metric step S408, a Cash Withdrawal Outgoing Transaction Percent can be determined. This can be the percent of cash withdrawal transactions out of all outgoing transactions for this account.

In step S409, a Commercial Sex Advertisement Transaction Count can be determined. This can be the count of transactions in this account which were categorized as commercial sex advertisement payments. Artificial intelligence, machine learning, and/or the like may be useful in these determinations.

In step S410, a determination can be made as to whether there is a Suspicious Activity Report Indicator for the company. If any party within this spa's related party network has a SAR, this indicator can be set to true.

In IMB scoring metric step S411, a potential Has Logistics Indicator can be set. In particular, if any party within this spa's related party network has a NAICS code or business description related to logistics, freight, or transport, this indicator can be set to true. Artificial intelligence, machine learning, and/or the like may be useful in this scoring metric.

In step S412, a Crypto Transaction Count can be calculated. This can be the count of transactions in this account which were categorized as cryptocurrency transactions.

In scoring step S413, a Burner Phone Transaction Count can be tabulated. This can be the count of transactions in this account which were categorized as payments made to burner phone apps or businesses.

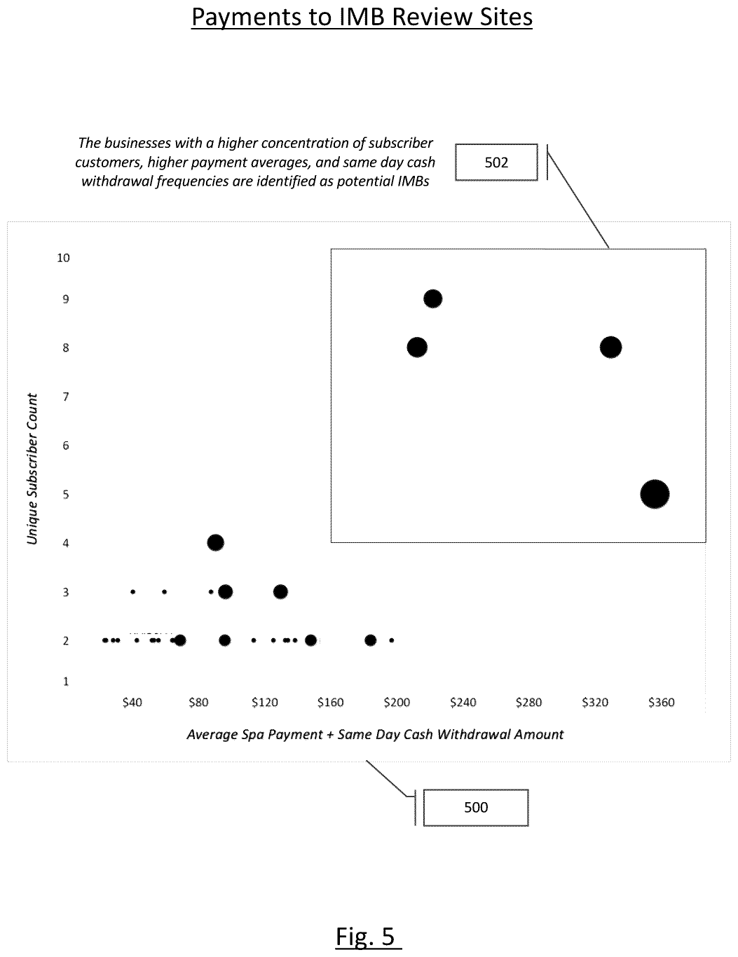

FIG. 5 is a sample high-level graphical analysis (e.g., histogram) for data relating to payments to IMB review sites. Subscriber counts can be correlated to average spa payments+same-day cash withdrawal (and/or same-day credit-card cash advance) amounts as shown in 500. Payments to IMB review sites in which businesses with a higher concentration of subscriber customers, higher payment averages, and same day cash withdrawal frequencies can be identified as potential IMBs as reflected in box 502. Artificial intelligence, machine learning, and/or the like may be useful identifying the relevant clusters and data result set.

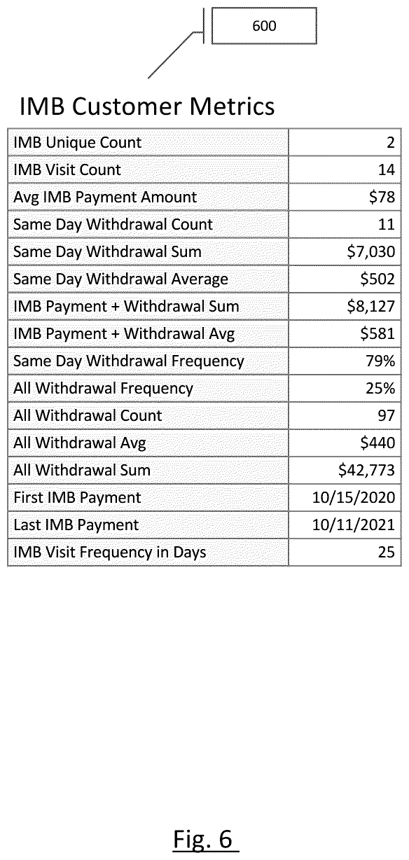

FIG. 6 depicts sample IMB customer metrics that can be utilized to implement one or more aspects of this disclosure. Sample IMB customer metrics are listed in table 600 and can including various data such as, for example, an IMB Unique Count, IMB Visit Count, Avg IMB Payment Amount, Same Day Withdrawal Count, Same Day Withdrawal Sum, Same Day Withdrawal Average, IMB Payment+Withdrawal Sum, IMB Payment+Withdrawal Avg, Same Day Withdrawal Frequency, All Withdrawal Frequency, All Withdrawal Count, All Withdrawal Avg, All Withdrawal Sum, First IMB Payment, Last IMB Payment, IMB Visit Frequency in Days, etc.

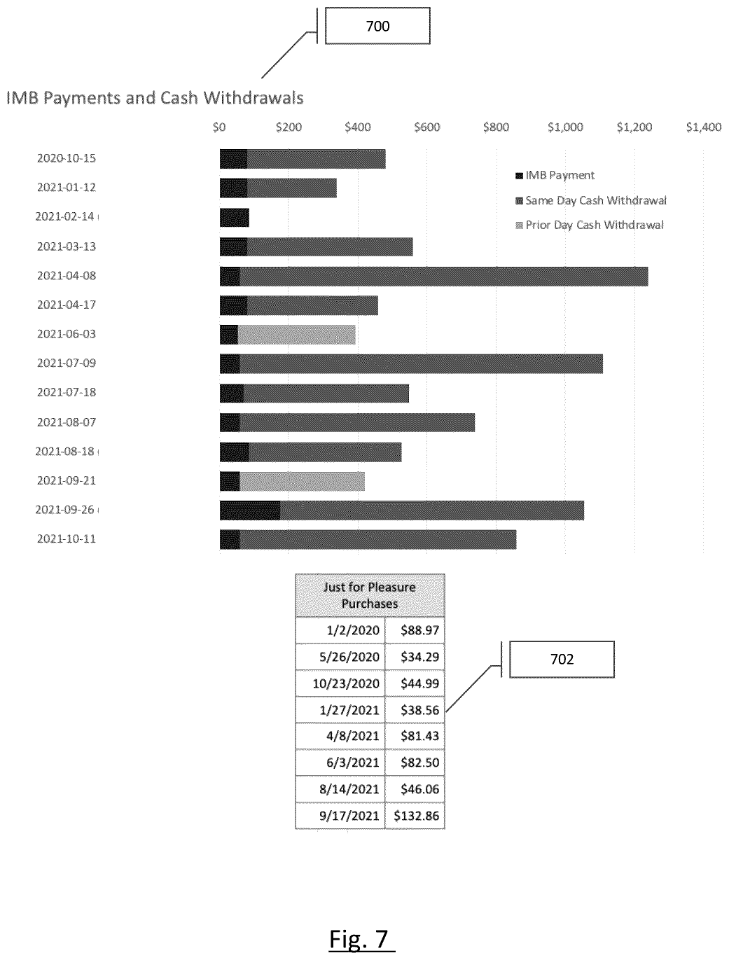

FIG. 7 depicts sample IMB payments and cash withdrawals by date as well as just for pleasure purchases that can be utilized to implement one or more aspects of this disclosure. In table 700, IMB payments and cash withdrawals (or cash advances) can be correlated by amount and date, including same-day withdrawals/advances or other recent activity such as transactions for a prior day. Tables like 702 can be generated for just for pleasure purchases as well.

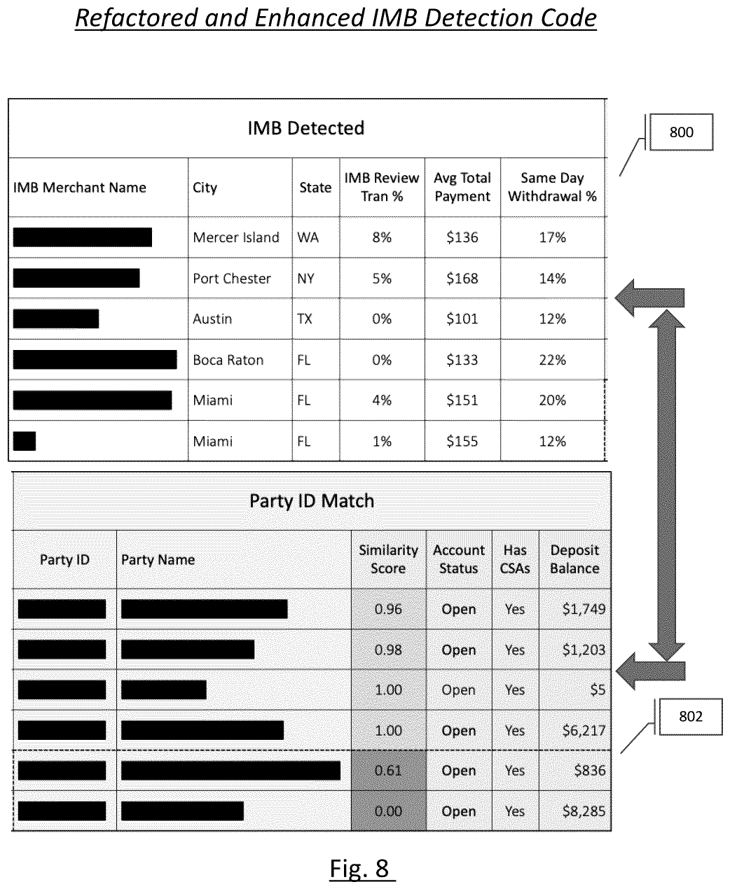

FIG. 8 is a sample high-level overview in which various aspects of this disclosure pertaining to refactored and enhanced IMB detection code can be utilized to implement one or more aspects of this disclosure.

As illustrated in FIG. 8, IMB Detection code can run against some or all of a total retail population. The ability to focus on one area can be maintained if desired, but is not required. IMB Merchants can me matched to Party IDs by artificial intelligence, machine learning, and/or natural language processing logic (e.g., by using string similarity methodology). IMB Detection results 800 can be prioritized based on multiple factors including IMB and buyer behavior as well as Party ID matching 802.

{\displaystyle \sigma (\mathbf {z})_ {i}={\frac {e\hat{ }{\beta z . . . {i}}}{\sum_{j=1}\hat{ }{K}e\hat{ }{\beta z_{j}}}}{\text{or}}\sigma (\mathbf {z})_{i}={\frac {e\hat{ }{-\beta z . . . {i}}}{\sum_{j=1}\hat{ }{K}e\hat{ }{-\beta z . . . {j}}}}{\text{for}}i=1,\dotsc, K.} Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computer-implemented human-trafficking detection process comprising the steps of:
(a) identifying, by a human-trafficking detection server from a subscriber datastore, a list of one or more subscribers to analyze based on detection criteria;
(b) retrieving, by the human-trafficking detection server from the subscriber datastore into a first sector of server memory, one or more subscribers to analyze;
(c) retrieval, by the human-trafficking detection server from a financial transaction datastore into a second sector of the server memory, a plurality of subscriber financial transactions that were executed by said one or more subscribers, said plurality of subscriber transactions having transaction amounts;
(d) storing, by the human-trafficking detection server in a third sector of server memory, the transaction amounts by transaction date;
(e) filtering, by the human-trafficking detection server based on business type, the plurality of subscriber financial transactions to identify suspect businesses potentially providing sex-buyer services;
(f) storing, by the human-trafficking detection server in a fourth sector of server memory, the plurality of subscriber financial transactions;
(g) retrieving, by the human-trafficking detection server from an ATM datastore, cash withdrawals and cash advances by the subscriber;
(h) storing, by the human-trafficking detection server in a fifth sector of server memory, the cash withdrawals and the cash advances by ATM date;
(i) calculating, by the human-trafficking detection server, summations of the cash withdrawals, the cash advances, and the transaction amounts based on the transaction date and the ATM date;
(j) storing, by the human-trafficking detection server into a sixth sector of the server memory, the summations based on the transaction date and the ATM date;
(k) identifying, by the human-trafficking detection server, potential sex businesses from the suspect businesses based on a correlation of the summations of the cash withdrawals and the cash advances to the transaction amounts by said transaction date and said ATM date, wherein said suspect businesses are more likely to be said potential sex businesses based on a concentration of a quantity of subscribers having higher average summations; and
(l) storing, by the human-trafficking detection server into a seventh sector of server memory, the potential sex businesses.

2. The computer-implemented human-trafficking detection process of claim 1 wherein the ATM date and the transaction date are the same.

3. The computer-implemented human-trafficking detection process of claim 2 wherein the business type is identified by a merchant category code.

4. The computer-implemented human-trafficking detection process of claim 3 wherein said identification of said potential sex businesses is determined utilizing artificial intelligence or machine learning.

5. The computer-implemented human-trafficking detection process of claim 4 wherein said artificial intelligence is selected from the group consisting of: Naive Bayes, Decision Tree, Random Forest, Support Vector Machines, K Nearest Neighbors, Linear Regression, Lasso Regression, Logistic Regression, Multivariate Regression, Multiple Regression, K-Means Clustering, Fuzzy C-mean, Expectation-Maximisation, and Hierarchical Clustering.

6. The computer-implemented human-trafficking detection process of claim 3 wherein said machine learning is selected from the group of: supervised machine learning, semi-supervised machine learning, unsupervised machine learning, and natural language processing.

7. The computer-implemented human-trafficking detection process of claim 3 wherein the identification of said potential sex businesses is determined by executing one or more IMB detection steps.

8. The computer-implemented human-trafficking detection process of claim 7 wherein said one or more IMB detection steps includes:
(a) calculating, by the human-trafficking detection server, an IMB subscriber review total;
(b) calculating, by the human-trafficking detection server, a spa/salon merchant total;
(c) calculating, by the human-trafficking detection server, an IMB detection total;
(d) calculating, by the human-trafficking detection server, an initial party ID match total;
(e) calculating, by the human-trafficking detection server, a high confidence party ID match total;
(f) calculating, by the human-trafficking detection server, an identification of open accounts; and
(g) calculating, by the human-trafficking detection server, an identification of said open accounts that have made one or more commercial sex advertisement payments,
wherein a likelihood of whether the potential sex business is an IMB is directly proportional to a cumulation of said one or more IMB detection steps.

9. The computer-implemented human-trafficking detection process of claim 3 wherein the identification of said potential sex businesses is determined by executing one or more IMB scoring metrics.

10. The computer-implemented human-trafficking detection process of claim 9 wherein said one or more IMB scoring metrics include:
(a) determining, by the human-trafficking detection server, a sex buyer site subscriber percent;
(b) calculating, by the human-trafficking detection server, an average spa/salon payment transaction amount;
(c) identifying, by the human-trafficking detection server, a same day withdrawal percentage;
(d) calculating, by the human-trafficking detection server, an average same day withdrawal amount;
(e) determining, by the human-trafficking detection server, a network party count;
(f) determining, by the human-trafficking detection server, a network spa count;
(g) calculating, by the human-trafficking detection server, a cash deposit incoming transaction percentage;
(h) calculating, by the human-trafficking detection server, a cash withdrawal outgoing transaction percentage;
(i) identifying, by the human-trafficking detection server, a commercial sex advertisement transaction count;
(j) determining, by the human-trafficking detection server, whether one or more said potential sex businesses has a suspicious activity report indicator;
(k) determining, by the human-trafficking detection server, whether one or more said potential sex businesses has a NAICS code or business description related to logistics, freight, or transport;
(l) calculating, by the human-trafficking detection server, a cryptocurrency transaction account; and
(m) calculating, by the human-trafficking detection server, a burner phone transaction count,
wherein a likelihood of whether the potential sex business is an IMB is directly proportional to a cumulation of said one or more IMB scoring metrics.

11. The computer-implemented human-trafficking detection process of claim 9 wherein the identification of said potential businesses is also determined by executing one or more IMB scoring metrics.

12. The computer-implemented human-trafficking detection process of claim 11 wherein said one or more IMB scoring metrics includes:
(a) determining, by the human-trafficking detection server, a sex buyer site subscriber percent;
(b) calculating, by the human-trafficking detection server, an average spa/salon payment transaction amount;
(c) identifying, by the human-trafficking detection server, a same day withdrawal percentage;
(d) calculating, by the human-trafficking detection server, an average same day withdrawal amount;
(e) determining, by the human-trafficking detection server, a network party count;
(f) determining, by the human-trafficking detection server, a network spa count;
(g) calculating, by the human-trafficking detection server, a cash deposit incoming transaction percentage;
(h) calculating, by the human-trafficking detection server, a cash withdrawal outgoing transaction percentage;
(i) identifying, by the human-trafficking detection server, a commercial sex advertisement transaction count;
(j) determining, by the human-trafficking detection server, whether one or more said potential sex businesses has a suspicious activity report indicator;
(k) determining, by the human-trafficking detection server, whether one or more said potential sex businesses has a NAICS code or business description related to logistics, freight, or transport;
(l) calculating, by the human-trafficking detection server, a cryptocurrency transaction account; and
(m) calculating, by the human-trafficking detection server, a burner phone transaction count, wherein a likelihood of whether the potential sex business is an IMB is directly proportional to a cumulation of said one or more IMB scoring metrics.

13. The computer-implemented human-trafficking detection process of claim 12 wherein said identification of said potential sex businesses is determined utilizing artificial intelligence or machine learning.

14. The computer-implemented human-trafficking detection process of claim 13 wherein said artificial intelligence or said machine learning is utilized to identify criminal networks based on one or more relationships between said potential sex businesses.

15. The computer-implemented human-trafficking detection process of claim 13 wherein said artificial intelligence is selected from the group consisting of: Naive Bayes, Decision Tree, Random Forest, Support Vector Machines, K Nearest Neighbors, Linear Regression, Lasso Regression, Logistic Regression, Multivariate Regression, Multiple Regression, K-Means Clustering, Fuzzy C-mean, Expectation-Maximisation, and Hierarchical Clustering.

16. The computer-implemented human-trafficking detection process of claim 13 wherein said machine learning is selected from the group of: supervised machine learning, semi-supervised machine learning, unsupervised machine learning, and natural language processing.

17. The computer-implemented human-trafficking detection process of claim 14 in which the steps are implemented as computer-executable instructions stored on computer-readable media.

18. The computer-implemented human-trafficking detection process of claim 15 in which the steps are implemented as computer-executable instructions stored on computer-readable media.

19. A computer-implemented artificial-intelligence based human-trafficking detection process comprising the steps of:
(a) identifying, by a human-trafficking detection server from a subscriber datastore, a list of one or more subscribers to analyze based on detection criteria;
(b) retrieving, by the human-trafficking detection server from the subscriber datastore into a first sector of server memory, one or more subscribers to analyze;
(c) retrieval, by the human-trafficking detection server from a financial transaction datastore into a second sector of the server memory, a plurality of subscriber financial transactions that were executed by said one or more subscribers, said plurality of subscriber transactions having transaction amounts;
(d) storing, by the human-trafficking detection server in a third sector of server memory, the transaction amounts by transaction date;
(e) filtering, by the human-trafficking detection server based on merchant category code, the plurality of subscriber financial transactions to identify suspect businesses potentially providing sex-buyer services;
(f) storing, by the human-trafficking detection server in a fourth sector of server memory, the plurality of subscriber financial transactions;
(g) retrieving, by the human-trafficking detection server from an ATM datastore, cash withdrawals and cash advances by the subscriber;
(h) storing, by the human-trafficking detection server in a fifth sector of server memory, the cash withdrawals and the cash advances by ATM date;
(i) calculating, by the human-trafficking detection server, summations of the cash withdrawals, the cash advances, and the transaction amounts based on the transaction date and the ATM date;
(j) storing, by the human-trafficking detection server into a sixth sector of the server memory, the summations based on the transaction date and the ATM date;
(k) utilizing, by the human-trafficking detection server, artificial intelligence to identify potential sex businesses from the suspect businesses based on:
(i) a correlation of the summations of the cash withdrawals and the cash advances to the transaction amounts by said transaction date and said ATM date, wherein said suspect businesses are more likely to be said potential sex businesses based on a concentration of a quantity of subscribers having higher average summations,
(ii) one or more IMB detection steps,
(iii)one or more IMB scoring metrics; and
(l) storing, by the human-trafficking detection server into a seventh sector of server memory, the potential sex businesses.

20. A computer-implemented artificial-intelligence based human-trafficking detection process comprising the steps of:
(a) identifying, by a human-trafficking detection server from a subscriber datastore, a list of one or more subscribers to analyze based on detection criteria;
(b) retrieving, by the human-trafficking detection server from the subscriber datastore into a first sector of server memory, one or more subscribers to analyze;
(c) retrieving, by the human-trafficking detection server from a financial transaction datastore into a second sector of the server memory, a plurality of subscriber financial transactions that were executed by said one or more subscribers, said plurality of subscriber transactions having transaction amounts;
(d) storing, by the human-trafficking detection server in a third sector of server memory, the transaction amounts by transaction date;
(e) filtering, by the human-trafficking detection server based on merchant category code, the plurality of subscriber financial transactions to identify suspect businesses potentially providing sex-buyer services;
(f) storing, by the human-trafficking detection server in a fourth sector of server memory, the plurality of subscriber financial transactions;
(g) retrieving, by the human-trafficking detection server from an ATM datastore, cash withdrawals and cash advances by the subscriber;
(h) storing, by the human-trafficking detection server in a fifth sector of server memory, the cash withdrawals and the cash advances by ATM date;
(i) calculating, by the human-trafficking detection server, summations of the cash withdrawals, the cash advances, and the transaction amounts based on the transaction date and the ATM date;
(j) storing, by the human-trafficking detection server into a sixth sector of the server memory, the summations based on the transaction date and the ATM date;
(k) utilizing, by the human-trafficking detection server, artificial intelligence to identify potential sex businesses from the suspect businesses based on:
(i) a correlation of the summations of the cash withdrawals and the cash advances to the transaction amounts by said transaction date and said ATM date, wherein said suspect businesses are more likely to be said potential sex businesses based on a concentration of a quantity of subscribers having higher average summations,
(ii) one or more IMB detection steps selected from the group consisting of:
(1) determining, by the human-trafficking detection server, a sex buyer site subscriber percent,
(2) calculating, by the human-trafficking detection server, an average spa/salon payment transaction amount,
(3) identification, by the human-trafficking detection server, a same day withdrawal percentage,
(4) calculating, by the human-trafficking detection server, an average same day withdrawal amount,
(5) determining, by the human-trafficking detection server, a network party count,
(6) determining, by the human-trafficking detection server, a network spa count,
(7) calculating, by the human-trafficking detection server, a cash deposit incoming transaction percentage,
(8) calculating, by the human-trafficking detection server, a cash withdrawal outgoing transaction percentage,
(9) identifying, by the human-trafficking detection server, a commercial sex advertisement transaction count,
(10) determining, by the human-trafficking detection server, whether one or more said potential sex businesses has a suspicious activity report indicator,
(11) determining, by the human-trafficking detection server, whether one or more said potential sex businesses has a NAICS code or business description related to logistics, freight, or transport,
(12) calculating, by the human-trafficking detection server, a cryptocurrency transaction account,
(13) calculating, by the human-trafficking detection server, a burner phone transaction count; and
(iii) one or more IMB scoring metric steps selected from the group consisting of:
(1) determining, by the human-trafficking detection server, a sex buyer site subscriber percent,
(2) calculating, by the human-trafficking detection server, an average spa/salon payment transaction amount,
(3) identification, by the human-trafficking detection server, a same day withdrawal percentage,
(4) calculating, by the human-trafficking detection server, an average same day withdrawal amount,
(5) determining, by the human-trafficking detection server, a network party count;
(6) determining, by the human-trafficking detection server, a network spa count;
(7) calculating, by the human-trafficking detection server, a cash deposit incoming transaction percentage,
(8) calculating, by the human-trafficking detection server, a cash withdrawal outgoing transaction percentage,
(9) identifying, by the human-trafficking detection server, a commercial sex advertisement transaction count,
(10) determining, by the human-trafficking detection server, whether one or more said potential sex businesses has a suspicious activity report indicator,
(11) determining, by the human-trafficking detection server, whether one or more said potential sex businesses has a NAICS code or business description related to logistics, freight, or transport,
(12) calculating, by the human-trafficking detection server, a cryptocurrency transaction account,
(13) calculating, by the human-trafficking detection server, a burner phone transaction count; and
(l) storing, by the human-trafficking detection server into a seventh sector of server memory, the potential sex businesses.
